(19) United States
(12) Patent Application Publication
(10) Pub. No.: US 2005/0200281 A1
(43) Pub. Date: Sep. 15, 2005

(54) Seal for a discharge lamp

(76) Inventors: Gerald Frederik Belder, EINDHOVEN (NL); Martinus Joseph Maria Kessels, Eindhoven (NL); Antonius Cornelis Van Amstel, Eindhoven (NL); Bart Theresia Verlinden, Eindhoven (NL); Andreas Sebastianus Gertrudis Geven, Eindhoven (NL); Mark Bolech, Eindhoven (NL); Henricus Peter Maria Gubbels, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/513,748

(22) PCT Filed: May 8, 2003
(86) PCT No.: PCT/IB03/01928

§ 371 Date: Nov. 5, 2004

(30) Foreign Application Priority Data
May 10, 2002 (EP) 02076849.5

(51) Int. Cl. H01J 17/18

(52) U.S. Cl. 313/626

(57) ABSTRACT

The invention relates to an electric discharge lamp comprising:—a light-transmissive ceramic discharge vessel (1) enclosing a discharge space (100)—a first and a second current conductor (2,3) entering the discharge vessel (1) and each supporting an electrode (4,5) in the discharge vessel (1);—a sealing compound (6) sealing the current conductors (2,3) in the discharge vessel (1) in a gas tight manner,—an ionizable filling comprising a rare gas and metal halide in the discharge vessel (1), both current conductors (2,3) extending from the sealing compound (6) to the exterior of the discharge vessel (1). According to the invention the sealing

The invention relates to an electric discharge lamp comprising:
a light-transmissive ceramic discharge vessel enclosing a discharge space;
a first and a second current conductor entering the discharge vessel and each supporting an electrode in the discharge vessel;
a sealing compound sealing the current conductors in the discharge vessel in a gas tight manner, and both current conductors extending from the sealing compound to the exterior of the discharge vessel,
an ionizable filling comprising a rare gas and metal halide in the discharge vessel.

Such an electric lamp is known from EP-A-0 587 238. In the known lamp the sealing compound is formed by a ceramic sealing compound. The sealed in current conductors each form a leadthrough.

In this specification and claims ceramic discharge vessel means a discharge vessel having a wall made of translucent metal oxide or metal nitride. Suitable metal oxides can be monocrystalline like sapphire or densely sintered polycrystalline like alumina and YAG. Suitable metal nitride is for instance densely sintered AlN

The sealed in current conductors of such a lamp must have a linear coefficient of thermal expansion, which corresponds to that of the discharge vessel in order to prevent leakage of the lamp. Leakage may even occur during the manufacture of the lamp for instance when the lamp cools down after the sealing compound has been provided at a relatively high temperature.

Both the sealed in current conductors and the sealing compound must also be resistant to the ionizable filling of the lamp, particularly to halide.

Since the requirements imposed on expansion and chemical resistance are often not combined in one material, at least the first current conductor of the known lamp within the discharge vessel has a first halide-resistant part having a different expansion than the discharge vessel, and a second part which extends from the seal and is not halide-resistant but has a corresponding expansion. This part often consists of niobium, tantalum or an alloy thereof, metals which, due to their oxidation sensitivity at higher temperatures, should be screened from air by using an outer envelope for the lamp.

If the discharge vessel is relatively narrow and elongate, and if it has a vertical operating position, the halide and the halogen formed therefrom are particularly present in the lower portion of the discharge vessel. It is then sufficient when only the first current conductor has a first halide-resistant portion and is present in the lower part of the discharge vessel. However, the lamp can then not be operated upside down, horizontally or obliquely. However, for obtaining a universal operating position, the lamp can be given a second current conductor corresponding to the first.

The first part of the current conductors of the known lamp generally comprises a molybdenum coil or a cermet of molybdenum and aluminum oxide.

It is a drawback of the known lamp that the ceramic sealing compound sealing the current conductors in the ceramic discharge vessel is attacked by the filling of the discharge vessel, in spite of the fact that the ceramic sealing compound in the known lamp is applied as remote as possible from a central part of the discharge vessel, i.e. at a free end of extended plugs (i.e. elongated parts) that are connected by way of sintering to the central part of the discharge vessel.

It is an object of the present invention to obviate the drawback and in order to accomplish that objective an electric lamp of the type referred to in the introduction according to the invention is characterized in that the sealing compound is a sealing braze and comprises a metal chosen from the group platinum, palladium, rhodium and iridium. It has emerged that a sealing braze comprising one or more of the said metals is very stable with respect to the ionizable filling in the discharge vessel also at high (operating) temperatures of the lamp. Besides the coefficient of thermal expansion of such a braze matches that of the discharge vessel. To further improve the quality of the sealing of the discharge vessel the sealing braze preferably also comprises an element chosen from the group formed by Ni, B, Si, Ti, Zr, Y and Nb. The addition of one or more of the elements B, Si, Ti, Zr and Y are in particular advantageous to result in an improved adherence between the braze at the one hand and the vessel and the current conductor respectively at the other hand. An addition of one or more of the elements Ni, B, Si and Nb is particular advantageous in controlling the melting point of the braze material.

Preferably in a lamp according to the invention the sealing braze comprises the metals Pt, Pd, Rh and Ir in an atom percentage ≧45. It appeared that with a relative high atom percentage of the said metals the risk on an unsatisfactory formed sealing braze during lamp fabrication is neglectible.

If in a lamp according to the invention the current conductor is fully or partly made of non halide resistant materials like Nb and Ta it is advantageous to have the sealing braze covering the current conductor over its full extend inside the discharge vessel. As the sealing braze is highly resistant to the ionizable filling of the discharge vessel also at high temperatures during lamp operation the current conductor is thus effectively protected.

In a further preferred embodiment of the lamp according to the invention the discharge vessel is free of extended plugs. An advantage of this embodiment is the possibility to further reduce the discharge vessel size resulting in a very compact lamp construction.

In a further advantageous embodiment of a lamp according to the invention one of the first and second current conductor is provided at the location where it extends from the sealing to the exterior of the discharge vessel with a coil extending away from the discharge vessel. It provides a simple and reliable means during lamp making to control the position of the current conductor relative to the discharge vessel. By a suitable choice of the material of the coil with respect to sealing compound it additionally will improve the direction of flowing of the molten sealing compound when forming of the sealing braze during the lamp making.

As the sealing braze is resistant to the ionizable filling of the lamp, particularly to halide, also at high operating temperatures of the present lamp, and as it protects the current conductor against the ionizable filling mentioned above, according to the invention there is no necessity to use a two-part form for a current conductor. Thus a resulting advantage of the invention is the use of a one-piece current conductor, for instance of niobium, tantalum or an alloy thereof.

The ionizable filling may not only comprise a rare gas as an ignition gas such as, for example argon, but also one or more metal halides, in general a mixture consisting of sodium iodide, thallium iodide, calcium iodide and one or more rare earth iodides.

These and other aspects of the invention are apparent from and will be elucidated with reference to the embodiments described hereinafter.

In the drawing:

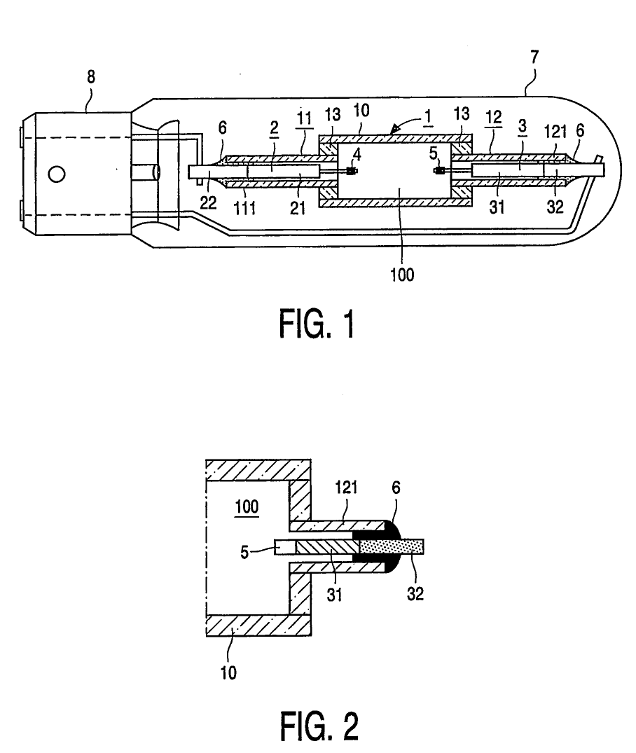

FIG. 1 shows a first embodiment of a lamp according to the invention in a side elevation, partly in a cross-section;

FIG. 2 shows a detail of the sealing construction of the lamp of FIG. 1, and

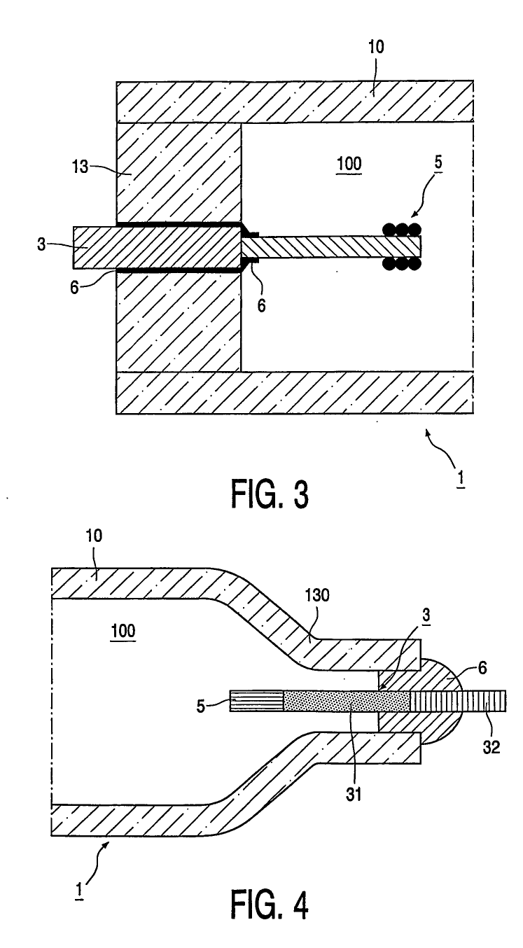

FIG. 3 to 7 showing alternative discharge vessel sealing constructions.

FIGS. 1 to 7 are not to scale.

FIG. 1 shows an electric discharge lamp according to the invention provided with a tubular, light-transmissive ceramic discharge vessel 1 made of translucent densely sintered polycrystalline aluminum oxide enclosing a discharge space 100, with a first and a second current conductor 2,3. Said conductors 2,3 enter the discharge vessel 1 opposite each other and each support a tungsten electrode 4,5 present in the discharge vessel 1 and welded to the current conductors 2,3. A sealing compound forms a sealing 6 as a sealing braze of the current conductors 2,3 in the discharge vessel 1 in a gas tight manner. The discharge vessel 1 has an ionizable filling comprising argon as a rare gas and a metal halide. A mixture comprising sodium iodide, thallium iodide, calcium iodide and one or more rare earth iodides, is one of the practical filling compositions.

Both the first and the second current conductors 2,3 each have a first halide-resistant part 21,31 within the discharge vessel 1 and, extending from the sealing braze 6 to the exterior of the discharge vessel, a second part 22,32 welded to the first part 21,31. In the shown embodiment the second part 22,32 of the current conductors 2,3 consists of niobium and is entirely covered by the sealing braze 6 in the discharge vessel 1. In the embodiment the first part 21,31 of the first and the second current conductor 2,3 comprises a cermet of molybdenum and aluminum oxide. In an alternative embodiment the first part 21, 31 of each of the current conductors is formed by an molybdenum coil. In a further alternative said first part is completely absent and both current conductors 2,3 consist of niobium.

The discharge vessel 1 has end parts 11,12 in which a respective current conductor 2,3 is enclosed. The end parts 11,12 have a free end 111,121, where the current conductor 3 is sealed in the discharge vessel 1 by the sealing braze 6. The central part 10 of the discharge vessel 1 is connected by way of sintering to the end parts 11,12 via ceramic discs 13. These end parts 11,12 may be (very) short in length or even absent, as the sealing braze material is stable with respect to the ionizable filling of the lamp (even at high operating temperatures thereof) and as the coefficient of thermal expansion of braze material matches that of the discharge vessel 1.

In FIG. 1 the discharge vessel 1 is enveloped by an outer envelope 7 which is sealed in a gas tight manner and is evacuated or filled with an inert gas in order to protect the niobium second parts 22,32 of the current conductors 2,3. The outer envelope 7 supports a lamp cap 8.

In FIG. 2 a detail of the sealing construction of the lamp of FIG. 1 is shown. In the FIG. 2 to 7 corresponding parts are indicated with the same reference numerals.

In FIG. 3 a detail of an alternative embodiment of a lamp according to the invention is shown. The discharge vessel 1 is free of extended plugs. Instead the current conductor 3 is directly fastened to the ceramic disc 13 forming the end closure of the discharge vessel. In the shown embodiment the current conductor is formed of one piece, for instance a Nb pen, to which the electrode 5 is connected at its end directed to the discharge space 100, for instance by a weld. The sealing braze material extends and thus covering the current conductor over its full extend inside the discharge vessel as well as over the connection of the electrode to the current conductor.

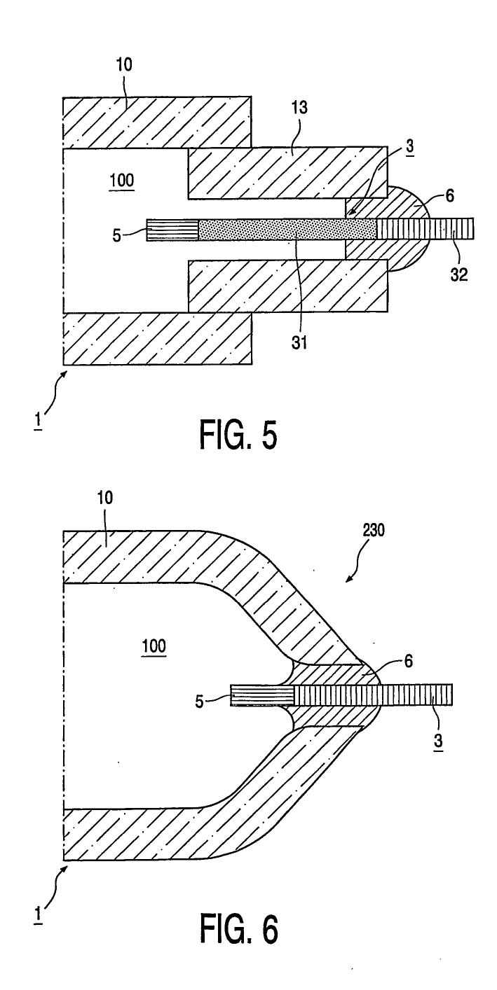

A few of many possible alternative shapes of discharge vessel end closure constructions are shown in FIG. 4 to 6. In FIG. 4 the discharge vessel has a neck shaped end 130 in which the current conductor 3 is sealed by the sealing braze 6. In FIG. 5 the end closure of the discharge vessel is formed by the ceramic disc, which protrudes outside the discharge vessel and thus forms an extended plug of reduced length. The current conductor is shown in both cases as a two-part conductor 31, 32. In a further alternative embodiments the current conductor is a one-piece element, preferably a suitable cermet. The embodiment shown in FIG. 6 has a cermet current conductor 3, which is sealed with a sealing braze 6 in a conical end 230 of the wall 10 of the discharge vessel 1.

In further alternatives (not shown) of the sealing construction of the lamp according to the invention the discharge vessel at the location of the sealing braze is provided with a metal coating of a refractory metal, preferably chosen from W and Mo. This means that the closure disc or the extended plug is provided with a metal coating at the location where the sealing is formed during the lamp fabrication as to improve the bonding between the braze material and the disc or plug. Alternatively to the metal coating the discharge vessel at the location of the sealing braze is formed as a cermet by the fact that the disc or plug forming the end closure of the discharge vessel being wholly or partly formed as a cermet.

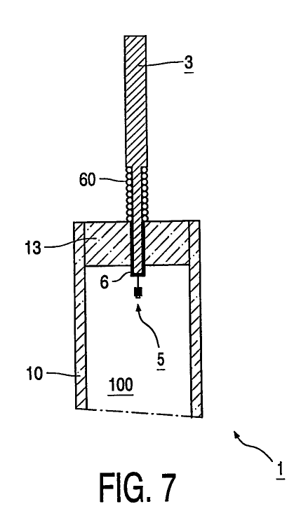

In FIG. 7 is shown an advantageous discharge vessel sealing construction in which the current conductor, for instance made of Nb, is provided at the location where it extends from the sealing to the exterior of the discharge vessel with a coil 60 extending away from the discharge vessel. During lamp making the coil has as an advantage that the length over which the current conductor sticks into the discharge vessel is relatively easily tuned. The coil may for instance be made of Mo, which has as further advantage that during the sealing process the sealing compound comprising for instance Pt will be forced into the discharge tube end due to the better wetting of the Nb current conductor with respect to the Mo coil.

A number of experiments have been done. In a first experiment a number of lamps have been made in which a sealing braze is formed comprising an alloy of 59 atom percentage Pt and 41 at. % Nb. The braze forms the sealing between a current conductor of Nb with weight % Zr and the polycrystalline wall of the discharge vessel. A first lamp has operated for over 8200 hours without showing on inspection any trace of damage to the seal. A further lamp has withstood an on-off switching mode of operation with more than 1800 switchings. Also in this case the sealing showed on inspection no trace of any damage.

In a different experiment the current conductor is formed by a Mo—Al₂O₃ cermet. The sealing braze comprises 94 at. % Pt, 4 at. % Zr and 2 at. % Ti. A sealing braze of the same composition was used in a further experiment in which also the wall of the discharge vessel at the sealing position was composed of a Mo—Al₂O₃ cermet.

Further experiments with a cermet current conductor have been done with in a first case a sealing braze comprising 97 at. % Pt, 1.5 at. % Zr and 1.5 at. % Ti and in a second case a sealing braze comprising 80 at. % Pt and 20 at. % Ni.

In a different experiment the current conductor is a solid pin of Nb. The wall of the discharge vessel at the sealing position is metalized before the sealing braze is formed. The resulting sealing braze comprised 70 at. % Pt and 30 at. % B.

In an alternative the sealing braze comprises 47 at. % Pd, 52 at. % Nb and 1 at. % Zr. In case of a current conductor made of Ta a successful sealing braze was formed comprising 37 at. % Pt, 13 at. % Pd and 50 at. % Ta.

All experiments resulted in a sealing between current conductor and discharge vessel of good quality.

In a further experiment the sealing braze comprised 42 at. % Pt and 58 at. % Nb. Of the made lamps over 50% was rejected due to imperfections in a sealing between discharge vessel and current conductor.

1. An electric discharge lamp comprising:
a light-transmissive ceramic lamp discharge vessel enclosing a discharge space;
a first and a second current conductor entering the lamp discharge vessel and each supporting an electrode in the lamp discharge vessel;
a sealing compound forming a sealing of the lamp vessel around the current conductors in the discharge vessel in a gas tight manner; with both current conductors, extending from the sealing to the exterior of the discharge vessel,
an ionizable filling comprising a rare gas and metal halide in the lamp discharge vessel, both current conductors, extending from the sealing compound to the exterior of the lamp vessel, characterized in that the sealing compound is a sealing braze at least substantially and comprises a noble metal chosen from the group, preferably platinum, palladium, rhodium and iridiumor an alloy of a noble metal, preferably platinum, and niobium.

2. An electric discharge lamp according to claim 1 wherein the sealing braze also comprises an element chosen from the group formed by Ni, B, Si, Ti, Zr, Y and Nb.

3. An electric discharge lamp according to claim 1 wherein wherein the sealing braze metals Pt, Pd, Rh and Ir are comprised in an atom percentage ≧45.

4. An electric discharge lamp according to claim 1 wherein the discharge vessel is free of extended plugs.

5. An electric discharge lamp according to claim 1 wherein one of the first and second current conductor is provided at the location where it extends from the sealing to the exterior of the discharge vessel with a coil extending away from the discharge vessel.

6. An electric discharge lamp according to claim 1 wherein the discharge vessel at the location of the sealing braze is provided with a metal coating of a refractory metal, preferably chosen from W and Mo.

7. An electric discharge lamp according to claim 1 wherein the discharge vessel at the location of the sealing braze is formed as a cermet.
